(19) United States
(12) Patent Application Publication
(10) Pub. No.: US 2025/0092265 A1
(43) Pub. Date: Mar. 20, 2025

(54) Method of Enhancing Carbon Product Performance in Elastomers

(71) Applicant: Beyond Lotus LLC, Wilmington, DE (US)

(72) Inventors: Frederick H. Rumpf, Billerica, MA (US); Michael D. Morris, Nashua, NH (US); Jincheng Xiong, Boxborough, MA (US); Michael Beaulieu, Bolton, MA (US); Michael Zhang, Westford, MA (US)

(21) Appl. No.: 18/720,647

(22) PCT Filed: Dec. 20, 2022
(86) PCT No.: PCT/US2022/082012

§ 371 Date: Jun. 16, 2024

Related U.S. Application Data
(60) Provisional application No. 63/292,049, filed on Dec. 21, 2021.

(51) Int. Cl. C09C 1/58; C08K 3/04

(52) U.S. Cl. CPC C09C 1/58; C08K 3/04; C08K 2201/003

(57) ABSTRACT

A method of processing particulate carbon comprises combining pyrolysis carbon with water to form a mixture to form an initial slurry having 1-35 wt % solids and milling the pyrolysis carbon to form a milled slurry comprising wet milled reclaimed carbon and water; wherein a volume weighted particle size distribution of the wet milled reclaimed carbon measured via scanning electron microscopy has one or more of D50 no greater than 2700 nm and no more than 15% of particles having a particle diameter greater than 5 microns.

### BACKGROUND OF THE INVENTION

### 1. Field of the Invention

This invention relates to methods for improved processing of reclaimed carbon black.

### 2. Description of the Related Art

End-of-life vehicle tires are frequently processed and reused in a wide range of end-use applications from playground equipment to concrete. However, it is desirable to recycle components of tires to obtain materials that can be combined with first-use materials to reduce the amount of new material required to produce new tires. Tires can be processed via pyrolysis, that is, heated in the absence of oxygen, to convert the elastomer to lower molecular weight hydrocarbons and recover a carbonaceous powder. However, the resulting powder is not equivalent to carbon black as a rubber reinforcing agent. Even in combination with carbon black, it delivers inferior fatigue performance and other mechanical properties. Therefore, to reduce the environmental impact of waste tires, it is desirable to improve the performance of particulate carbon recovered by pyrolysis from tires and other sources.

### SUMMARY OF THE INVENTION

As used herein, “char” means solid material resulting from pyrolysis of rubber goods.

As used herein, “dry milled reclaimed carbon” is pyrolysis carbon that is substantially free of macroscopic contaminants and that has been milled without the use of water and optionally pelletized.

As used herein, “carbon black” means elemental carbon-containing particles of carbon coalesced into aggregates and agglomerates and obtained by partial combustion or thermal decomposition of hydrocarbons.

As used herein, “raw reclaimed carbon” is solid material resulting from pyrolysis of rubber goods that contain carbonaceous particulate fillers, including but not limited to carbon black, in any amount.

As used herein, “processed reclaimed carbon” means raw reclaimed carbon that has been processed to remove at least one macroscopic contaminant such as fabric or wire.

As used herein, “pyrolysis carbon” includes char, raw reclaimed carbon, processed reclaimed carbon, and dry milled reclaimed carbon.

As used herein, “milled reclaimed carbon” or “milled rC” is pyrolysis carbon that is substantially free of macroscopic contaminants and that has been milled.

As used herein, “reclaimed carbon” is raw reclaimed carbon that has been processed to remove macroscopic contaminants and that has optionally been further milled. Thus, processed reclaimed carbon, milled reclaimed carbon, dry milled reclaimed carbon, and wet milled reclaimed carbon all fall under the definition of reclaimed carbon.

As used herein, “wet milled reclaimed carbon” is pyrolysis carbon that is substantially free of macroscopic contaminants and that has been milled in the presence of at least 50 wt %, preferably 65-99% water, based on the total weight of materials being milled.

In one embodiment, a method of processing particulate carbon includes combining pyrolysis carbon with water to form a mixture to form an initial slurry having 1-35 wt % solids and milling the pyrolysis carbon to form a milled slurry of wet milled reclaimed carbon and water. A volume weighted particle size distribution curve of the wet milled reclaimed carbon measured via scanning electron microscopy has one or more of D50 no greater than 2700 nm and no more than 15% of particles having a particle diameter greater than 5 microns, for example, D50 from 1000 to 2700 nm or from 1200 nm to 2500. Alternatively or in addition, the wet milled reclaimed carbon may have D75 from 2500 nm to 3300, for example, from 1700 to 3000. Alternatively or in addition, from 3% to 10% of the wet milled reclaimed carbon particles have a particle diameter greater than 5 microns. Alternatively or in addition, no more than 65% of the particles, for example from 25% to 60%, may have a particle diameter greater than 2 microns.

The method may further include removing macroscopic contaminants from the initial slurry, which may optionally have up to 25 wt % solids. Combining may further include combining at least one supplemental filler with the water to form the initial slurry. The supplemental filler may be selected from the group consisting of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, carbon black-coated particles, and mixtures of two or more of these. Milling may be performed with at least one apparatus selected from a cutter mixer, a ball mill, a media mill, a homogenizer, attritor, horizontal bead mill, rotor stator mill, and a colloid mill.

The method may further include adding at least one additional filler selected from carbon black, silicon treated carbon black, silica coated carbon black, coated carbon black particles, and precipitated silica to the milled slurry to bring the solids content of the resulting wet blended carbon mixture to 25-70 wt %. Adding may include adding an aqueous slurry comprising the at least one additional filler, adding additional water to the milled slurry, or both. The method may further include pelletizing the wet blended carbon mixture to form pellets or spray drying the wet blended carbon mixture and, optionally, drying the pellets.

The water may be a continuous stream of water, the milled slurry may be a continuous stream of the milled slurry, and combining may include metering the pyrolysis carbon into the continuous stream of water. Combining may further include metering at least one supplemental filler into the continuous stream of water. The supplemental filler may be selected from the group consisting of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, carbon black-coated particles, and mixtures of two or more of these. The method may further include metering at least one additional filler selected from carbon black, silicon treated carbon black, silica coated carbon black, carbon black coated particles, and precipitated silica into the continuous stream of the milled slurry to bring the solids content of the resulting continuous flow of wet blended carbon mixture to 25-70 wt % or 1-25 wt %. Metering may include metering an aqueous slurry of the additional filler into the continuous stream of the milled slurry, metering additional water into the continuous stream of the milled slurry, or both.

In any of these embodiments, the method may further include granulating the wet blended carbon mixture, e.g., by pelletizing the wet blended carbon mixture to form pellets or spray drying the wet blended carbon mixture. The pellets may be dried. The milled slurry may be spray dried or its solids otherwise granulated. For example, the milled slurry may be dehydrated to a predetermined moisture level and then pelletized.

In another embodiment, the invention includes pellets produced using any combination or subcombination of the method steps above.

In another embodiment, a particulate filler includes at least 10 wt % (dry basis), for example, 10-100 wt %, 10-90 wt %, 15-80 wt %, 20-60 wt %, or 30-50 wt %, reclaimed carbon. A volume weighted particle size distribution of the reclaimed carbon measured via scanning electron microscopy has one or more of D50 no greater than 2700 nm and no more than 15% of particles having a particle diameter greater than 5 microns. For example, the reclaimed carbon may have D50 from 1000 to 2700 nm or from 1200 nm to 2500. Alternatively or in addition, the reclaimed carbon may have D75 from 2500 nm to 3300, for example, from 1700 to 3000. Alternatively or in addition, from 3% to 10% of the reclaimed carbon may have a particle diameter greater than 5 microns. Alternatively or in addition, no more than 65%, for example from 25% to 60%, of the reclaimed carbon may have a particle diameter greater than 2 microns.

In any of these embodiments, the particulate filler may further include one or more supplemental fillers selected from carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures and carbon black-coated particles. The particulate filler may have a moisture content of 15 to 80 wt %, for example 40-60 wt %.

The particulate filler may be in the form of pellets. The pellets may include 15-80% water, for example, 40-60% water, or may include no more than 3% water and/or may consist substantially of particulate filler, optional water, and optional binder. A pellet may contain particulate filler according to any of these embodiments and at least one additional filler selected from carbon black, silicon treated carbon black, silica coated carbon black, carbon black-coated particles, and precipitated silica.

In any of these embodiments, the reclaimed carbon may be wet milled reclaimed carbon.

In another embodiment, an elastomer composite includes a mixture of an elastomer and 30-90 phr particulate filler, for example, 30-70, 35-60, or 40-55 phr. The particulate filler includes at least 10 wt % reclaimed carbon, for example, 10-100 wt %, 10-90 wt %, 15-80 wt %, 20-60 wt %, or 30-50 wt % reclaimed carbon. The reclaimed carbon has one or more of D50 (volume weighted) no greater than 2700 nm and no more than 15% (volume weighted) of particles having a particle diameter greater than 5 microns as measured by scanning electron microscopy in particulate form, i.e., prior to being mixed with the elastomer. For example, reclaimed carbon may have D50 from 1000 to 2700 nm or from 1200 nm to 2500. Alternatively or in addition, the reclaimed carbon may have D75 from 2500 nm to 3300, for example, from 1700 to 3000. Alternatively or in addition, from 3% to 10% of the reclaimed carbon may have a particle diameter greater than 5 microns. Alternatively or in addition, no more than 65%, for example from 25% to 60%, of the reclaimed carbon may have a particle diameter greater than 2 microns. The particulate filler may further include one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.

In any of these embodiments, the elastomer may be selected from natural rubbers, functionalized natural rubbers, styrene-butadiene rubbers, functionalized styrene-butadiene rubbers, polybutadiene rubbers, functionalized polybutadiene rubbers, polyisoprene rubbers, ethylene-propylene copolymers, isobutylene-based rubbers, polychloroprene rubbers, nitrile rubbers, hydrogenated nitrile rubbers, polysulfide rubbers, polyacrylate elastomers, fluoroelastomers, perfluoroelastomers, and blends thereof.

In any of these embodiments, the elastomer composite may exhibit a macrodispersion of at most 0.03x+4.4, for example, from 0.03x to 0.03x+4.4, wherein x is the percentage of reclaimed carbon in the particulate filler and macrodispersion is an area percentage of undispersed filler particles larger than 5 μm determined by optical microscopy in reflection mode. Where the particulate filler is reclaimed carbon and carbon black, the elastomer composite may exhibit macrodispersion of at most 1.9 ln(x)+1.2, for example from 1.9 ln(x)−3.2 to 1.9 ln(x)+0.2.

In any of these embodiments, the reclaimed carbon may be wet milled reclaimed carbon. In any of these embodiments, the elastomer composite may be a vulcanized elastomer composite.

A tire tread may include a vulcanizate of a mixture of the elastomer composite with a curative package. Alternatively or in addition, an article may include a vulcanizate of a mixture of the elastomer composite with a curative package. The article may be incorporated in pneumatic tires, non-pneumatic tires, or solid tires. The article may be selected from tire treads, undertread, innerliners, sidewalls, sidewall inserts, wire-skim, and cushion gum for retread tires. The article may be selected from hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, oil, aerospace, and other applications, propeller shafts, pipe linings, engine mounts, bushings, weather stripping, windshield wipers, automotive components, seals, gaskets, housings, wheel elements, and track elements.

Alternatively or in addition, a vulcanizate of a mixture of the elastomer composite with a curative package has fatigue properties equivalent to or at least 90% of those for a vulcanizate produced via the same process and with the same composition except with ASTM N550 carbon black in place of the reclaimed carbon. The vulcanizate may exhibit a macrodispersion of at most 0.03x+4.4, for example, from 0.03x to 0.03x+4.4, wherein x is the percentage of reclaimed carbon in the particulate filler and macrodispersion is an area percentage of undispersed filler particles larger than 5 μm determined by optical microscopy in reflection mode. Where the particulate filler is reclaimed carbon and carbon black, the vulcanizate may exhibit a macrodispersion of at most 1.9 ln(x)+0.2, for example, from 1.9 ln(x)−3.2 to 1.9 ln(x)+0.2.

In another embodiment, an elastomer composite comprises a mixture of an elastomer and 30-90 phr of particulate filler. In certain embodiments, the particulate filler comprises at least 10 wt % reclaimed carbon, and the elastomer composite exhibits a macrodispersion of at most 0.03x+4.4, for example, from 0.03x to 0.03x+4.4, wherein x is the percentage of reclaimed carbon in the particulate filler and macrodispersion is an area percentage of undispersed filler particles larger than 5 μm determined by optical microscopy in reflection mode. Where the particulate filler comprises at least 10 wt % (dry basis) reclaimed carbon with the balance carbon black, the macrodispersion is at most 1.9 ln(x)+1.2, for example, 1.9 ln(x)−3.2 to 1.9 ln(x)+0.2. In any of these embodiments, the elastomer composite may be vulcanized, and/or the reclaimed carbon may be wet milled reclaimed carbon. The reclaimed carbon may have one or more of D50 (volume weighted) no greater than 2700 nm and no more than 15% (volume weighted) of particles having a particle diameter greater than 5 microns as measured by scanning electron microscopy. For example, the reclaimed carbon may have D50 from 1000 to 2700 nm or from 1200 nm to 2500. Alternatively or in addition, the reclaimed carbon may have D75 from 2500 nm to 3300, for example, from 1700 to 3000. Alternatively or in addition, from 3% to 10% of the reclaimed carbon may have a particle diameter greater than 5 microns. Alternatively or in addition, no more than 65%, for example from 25% to 60%, of the reclaimed carbon may have a particle diameter greater than 2 microns.

It is to be understood that both the foregoing general description and the following detailed description are exemplary and explanatory only and are intended to provide further explanation of the present invention, as claimed.

### BRIEF DESCRIPTION OF THE DRAWING

The invention is described with reference to the several figures of the drawing, in which,

FIG. 1 shows particle size distributions for unprocessed char (dash dot, CBP Cyprus) which has been either jet milled (dashed line) or processed according to an exemplary embodiment (solid line).

FIG. 2 shows particle size distributions for samples of char (dashed line-CBP Cyprus, dash dot-Polimix Ambiental) and Polymix 300 processed reclaimed carbon (solid line) processed according to exemplary embodiments.

FIG. 3 shows particle size distributions for jet milled samples of char (dashed line-CBP Cyprus, dash dot-Polimix Ambiental) and Polymix 300 processed reclaimed carbon (solid line).

FIG. 4 shows the % undispersed aggregates having a diameter greater than 5 microns in filled elastomer composites as a function of the percentage of reclaimed carbon in the filler. Triangles indicate comparative samples and circles indicate samples prepared according to embodiments of the invention. Samples with 26.9% reclaimed carbon use blends of reclaimed carbon and precipitated silica as the filler; the remaining blends include carbon black.

### DETAILED DESCRIPTION OF THE INVENTION

In one embodiment, a method of processing particulate carbon includes combining pyrolysis carbon with water to form a mixture to form an initial slurry having 1-35 wt % solids and milling the pyrolysis carbon to form a milled slurry of wet milled reclaimed carbon and water. A volume weighted particle size distribution of the milled slurry measured via scanning electron microscopy has one or more of D50 no greater than 2700 nm and no more than 15% of particles having a particle diameter greater than 5 microns, for example, D50 from 1000 to 2700 nm or from 1200 nm to 2500. Alternatively or in addition, the milled slurry may have D75 from 2500 nm to 3300, for example, from 1700 to 3000. Alternatively or in addition, from 3% to 10% of the particles have a particle diameter greater than 5 microns. Alternatively or in addition, no more than 65% of the particles, for example from 25% to 60%, may have a particle diameter greater than 2 microns.

The pyrolysis carbon may include one or more of raw reclaimed carbon, processed reclaimed carbon, and dry milled reclaimed carbon. Preferably, the pyrolysis carbon is derived from rubber goods originally produced with carbon black. Pyrolysis may be performed by any method known to those of skill in the art. Exemplary methods include but are not limited to those found in U.S. Pat. No. 8,350,105 and US20180320082, the entire contents of both of which are incorporated herein by reference. The pyrolysis carbon is combined with water to form an initial slurry having a solids loading of 1-35%, for example, 5-30%, 7-25%, 10-20%, or 15-25% by weight. The loading is preferably coordinated with the loading needs of downstream processes including milling and optional pelletizing.

The pyrolysis carbon may be processed to remove macroscopic contaminants. For example, magnetic separation techniques known to those of skill in the art may be used to remove wires and other macroscopic metallic contaminants. Filters or screens may be used to remove fabric and other non-magnetic macroscopic contaminants. The pyrolysis carbon may be processed before being combined with the water to form the initial slurry and/or the initial slurry may be processed to removed macroscopic contaminants.

Alternatively or in addition, the pyrolysis carbon may be processed to remove ash, for example, by washing the pyrolysis carbon with acid or by using an ion exchanger. Exemplary methods are described in US20150307714, CN101357758, and WO2021/005124, the contents of all of which are incorporated herein by reference.

In some embodiments, the method is continuous. In these embodiments, pyrolysis carbon is continuously metered into a continuous stream of water to form a continuous stream of the initial slurry. The continuous stream of the initial slurry may be processed using techniques known to those of skill in the art to remove macroscopic contaminants.

The initial slurry, following any processing, is milled. Any technique known to those of skill in the art for milling or grinding a particulate slurry may be employed. Exemplary apparatus include a cutter mixer, a ball mill, a media mill, a homogenizer, attritor, horizontal bead mill, rotor stator mill, colloid mill, and other apparatus known to those of skill in the art. Milling may transform the pyrolysis carbon to a wet milled reclaimed carbon having a volume weighted particle size distribution measured via scanning electron microscopy characterized by one or both of D50 no greater than 2700 nm and no more than 15% of particles having a particle diameter greater than 5 microns. For example, D50 may be from 1000 to 2700 nm or from 1200 nm to 2500. Alternatively or in addition, the milled slurry may have D75 from 2500 nm to 3300, for example, from 1700 to 3000. Alternatively or in addition, from 3% to 10% of the particles have a particle diameter greater than 5 microns. Alternatively or in addition, no more than 65% of the particles, for example from 25% to 60%, may have a particle diameter greater than 2 microns. Without being bound by any particular theory, it is believed that the performance vulcanized elastomer composites produced with dry milled reclaimed carbon is degraded is due to the presence of large agglomerates that are poorly dispersed in the elastomer. The methods provided herein reduce agglomerate size more effectively, thereby improving filler dispersion in an elastomer matrix and improving the performance of the resulting vulcanized elastomer composite. The improved mechanical performance may be reflected in fatigue performance, tensile performance, tear performance, cut/chip performance, or in other properties typically measured on elastomer composites.

The particle size distribution may be measured using any appropriate method, for example, laser diffraction, known to those of skill in the art. Preferably, particle size distribution is measured using scanning electron microscopy, for example, the scanning electron microscopy method described in more detail in the examples. In brief, the particles are dispersed at a concentration of 0.2 wt % in water with 600 ppm of Triton X 100 surfactant at low speed and then stirred for 24 hours. The dispersion is diluted to an appropriate concentration, filtered onto a membrane filter, dried, sputter coated with a conductive material, and imaged. Imaging is conducted at high and low magnification to provide sufficient resolution to capture small particles while efficiently imaging large particles. Images are processed to minimize uneven image background, increase particle contrast, and reduce image noise while preserving the edges of the particles. The particle size distribution is determined by measuring Dcirc=2 (area of projected image/π)^{1/2} on at least 50000, typically 50,000 to 200,000 particles, at each magnification

The initial slurry may contain one or more supplemental fillers that may also benefit from being co-milled with the pyrolysis carbon. Any particulate filler that provides reinforcement or other beneficial properties to rubber may be employed. Exemplary supplemental fillers include but are not limited to carbon black, silicon treated carbon black, silica coated carbon black, precipitated silica, hydrothermal carbon (i.e., carbonaceous material produced by hydrothermal carbonization of lignin or other biomass, for example, as described in U.S. Pat. No. 10,428,218 or U.S. Pat. No. 10,035,957, the contents of both of which are incorporated herein by reference), engineered polysaccharides such as those described in US2020/181370 and US2020/190270, the contents of both of which are incorporated herein by reference, and graphene, graphene oxide, reduced graphene oxide, nanocellulose, lignin, clays, nanoclays, metal oxides, metal carbonates, single walled carbon nanotubes, multi walled carbon nanotubes, carbon nanostructures such as those described in US2014/0093728, the entire contents of which are incorporated herein by reference, and carbon-black coated particles such as those described in U.S. Pat. No. 10,519,298, the entire contents of which are incorporated herein by reference. Preferably, macroscopic contaminants are removed from the pyrolysis carbon, either in the dry or slurry state, prior to combining the pyrolysis carbon with the one or more supplemental fillers. The supplemental filler(s) may be combined with the pyrolysis carbon in the dry state or separately charged into the water, before, after, or simultaneously with the pyrolysis carbon to form the initial slurry. To avoid any segregation that may occur in dry mixtures of pyrolysis carbon and supplemental filler, the supplemental filler(s) are preferably charged directly into the water or initial slurry separately from the pyrolysis carbon. The ratio of pyrolysis carbon and supplemental filler in the initial slurry can be any range suitable for the desired end use application and to maintain acceptable viscosity of the initial slurry so that it can be milled. In a continuous process, the supplemental filler may be continuously metered into the initial slurry or into the continuous stream of water as a powder or as an aqueous slurry of supplemental filler (or more than one slurry if more than one supplemental filler is used). One of skill in the art will recognize that the appropriate loading for milling will depend on the nature of the supplemental filler. For example, carbon nanotubes will increase slurry viscosity at very low loadings, while higher loadings of precipitated silica may not increase viscosity dramatically.

An additional filler may also be added to the milled slurry. Such additional filler preferably does not require additional milling. Exemplary additional fillers for addition to the milled slurry include but are not limited to carbon black, silica coated carbon black, silica treated carbon black, precipitated silica, carbon black-coated particles such as those described in U.S. Pat. No. 10,519,298, and mixtures of two or more of these. Depending on the solids loading of the milled slurry, it may also be desirable to add water along with the additional filler to adjust the solids loading of the resulting wet blended carbon mixture. Alternatively or in addition, the additional filler may be added to the milled slurry as an aqueous slurry. In a continuous process, the additional filler may be continuously metered into the initial slurry or into the continuous stream of water as a powder or as an aqueous slurry of additional filler. The total filler loading may be such that the wet blended carbon mixture may be readily formed into pellets or spray dried. To form pellets, the additional filler and optional water added to the milled slurry may bring the solids content of the resulting wet blended carbon mixture to 25-70 wt %, for example, 30-65 wt %, 35-60 wt %, or 40-50 wt %. For spray drying, the additional filler and optional water added to the milled slurry may bring the solids content of the resulting wet blended carbon mixture to 1-30 wt %, for example, 1-10 wt %, 5-15 wt %, or 8-25 wt %. For spray drying, it may be desirable to omit the additional filler. One of skill in the art will recognize how to adjust the total filler loading to prepare desirable pellets or the optimal loading for spray drying in conventional apparatus. The filler(s) that is added to the milled slurry may be the same or different as any filler(s) added to the initial slurry.

Carbon black for use in any of the embodiments herein include but are not limited to ASTM N100 series-N900 series carbon blacks, for example N100 series carbon blacks, N200 series carbon blacks, N300 series carbon blacks, N500 series carbon blacks, N600 series carbon blacks, N700 series carbon blacks, N800 series carbon blacks, or N900 series carbon blacks. Carbon blacks sold under the Regal®, Black Pearls®, Spheron®, Sterling®, and Vulcan® trademarks available from Cabot Corporation, the Raven®, Statex®, Furnex®, and Neotex® trademarks and the CD and HV lines available from Birla Carbon (Columbian Chemicals,) and the Corax®, Durax®, Ecorax®, and Purex® trademarks and the CK line and other carbon blacks available from Orion Engineered Carbons, and other fillers suitable for use in rubber or tire applications, may also be exploited for use with various embodiments. Carbon blacks may be chemically functionalized. Suitable chemically functionalized carbon blacks include those disclosed in WO 96/18688 and US2013/0165560, the disclosures of which are hereby incorporated by reference.

The carbon black may have a statistical thickness surface area (STSA, ASTM Standard D6556) of at least about 15 m²/g, for example, from about 15 m²/g to about 240 m2/g, e.g., from about 35 m2/g to about 230 m2/g, from about 50 m2/g to about 200 m²/g, from about 60 m2/g to about 180 m2/g, from about 100 m²/g to about 200 m²/g.

Carbon blacks having any of the above surface areas may additionally have a structure, as given by the oil adsorption number for the compressed carbon black (COAN, ASTM D3493), of from about 50 to about 115 mL/100 g, for example, from about 65 to about 75 mL/100 g, from about 60 to 95 mL/100 g, from about 75 to about 85 mL/100 g, from about 85 to about 95 mL/100 g, from about 95 to about 105 mL/100 g, or from about 105 to about 115 mL/100 g.

Mixtures of any of these carbon blacks may be employed.

The materials described herein as silicon-treated carbon blacks are not limited to carbon black aggregates which have been coated or otherwise modified. They also may be a different kind of aggregate having two phases. One phase is carbon, which will still be present as graphitic crystallite and/or amorphous carbon, while the second phase is silica (and possibly other silicon-containing species). Thus, the silicon-containing species phase of the silicon-treated carbon black is an intrinsic part of the aggregate; it is distributed throughout at least a portion of the aggregate. A variety of silicon-treated blacks are available from Cabot Corporation under the Ecoblack™ name and are described in more detail in U.S. Pat. No. 6,028,137. It will be appreciated that the multiphase aggregates are quite different from the silica-coated carbon blacks mentioned above, which consist of pre-formed, single phase carbon black aggregates having silicon-containing species deposited on their surface. Such carbon blacks may be surface-treated in order to place a silica functionality on the surface of the carbon black aggregate as described in, e.g., U.S. Pat. Nos. 6,929,783, 6,541,113 and 5,679,728.

Suitable precipitated silicas for use in any of the embodiments herein include both highly dispersible (HDS) granules and non-HDS precipitated silicas. Precipitated silica may have been chemically treated to include functional groups such as coupling agents bonded (attached (e.g., chemically attached) or adhered (e.g., adsorbed)) to the silica surface. Examples of suitable grades of HDS include Perkasil® GT 3000GRAN silica from WR Grace & Co, Ultrasil® 7000 silica from Evonik Industries, Zeosil® 1165 MP and 1115 MP silica from Solvay S.A., Hi-Sil® EZ 160G silica from PPG Industries, Inc., and Zeopol® 8741 or 8745 silica from Evonik Industries. Examples of suitable grades of conventional (non-HDS) precipitated silica include Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Examples of suitable grades of hydrophobic precipitated silica include Agilon®400, 454, or 458 silica from PPG Industries, Inc. and Coupsil® silicas from Evonik Industries, for example Coupsil® 6109 silica.

The wet blended carbon mixture may be densified, e.g., granulated or pelletized. Any densification or pelletization method known to those of skill in the art may be employed. For example, the methods of U.S. Pat. No. 2,065,371 to Glaxner may be employed. In general, the wet blended carbon mixture is formed into beads, which may then be optionally dried to reduce the water content to at most 1% to form blended carbon pellets. In addition to the water already present in the wet blended carbon mixture, a wide variety of binder additives are known to be useful in the wet pelletization process to further improve the handling characteristics of the resulting pellets. Such additives include but are not limited to hygroscopic organic liquids such as ethylene glycol, carbohydrates (e.g., sugar, molasses, soluble starches, saccharides, lignin derivatives), rosin, sulfonate and sulfate anionic surfactants, fatty amine ethoxylate nonionic surfactants, sodium ligno sulfonates, silanes, sucrose, alkyl succinimides, alkylated succinic esters, and polyethylene oxide-co-polydimethyl siloxane surfactants. Alternatively or in addition, the pellets need not be dried and may be used wet, in which case it may not be necessary to use a binder. For example, wet pellets may have a moisture content of 15-80 wt %, for example 40-60 wt %.

The resulting particulate filler, in the form of wet pellets or dry pellets or some other form (e.g., a slurry prior to pelletization or other drying method), on a dry basis, may comprise 2-100 wt %, for example 5-98 wt % or 8-90 wt %, 10-60 wt %, 15-50 wt %, 10-100 wt % or 15-60 wt %, 10-90 wt %, 15-80 wt %, 20-60 wt %, or 30-50 wt %, or 20-50 wt %, reclaimed carbon, preferably wet milled reclaimed carbon, and with the balance being a filler other than reclaimed carbon, e.g. one or more of the additional and/or supplemental fillers listed above, e.g., carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles. The volume weighted particle size distribution of the reclaimed carbon and/or the overall particulate filler (i.e., the mixture of reclaimed carbon and other filler), measured via scanning electron microscopy, may have one or more of D50 no greater than 2700 nm and no more than 15% of particles having a particle diameter greater than 5 microns, for example, D50 from 1000 to 2700 nm or from 1200 nm to 2500. Alternatively or in addition, the reclaimed carbon and/or the overall particulate filler may have D75 from 2500 nm to 3300, for example, from 1700 to 3000. Alternatively or in addition, from 3% to 10% of the reclaimed carbon and/or the overall particulate filler may have a particle diameter greater than 5 microns. Alternatively or in addition, no more than 65% of the reclaimed carbon and/or overall particulate filler, for example from 25% to 60%, may have a particle diameter greater than 2 microns. As noted above, the pellets may also contain a binder. In all these embodiments, the reclaimed carbon is preferably wet milled reclaimed carbon.

Alternatively or in addition, the wet blended carbon mixture may be spray dried using any spray drying apparatus known to those of skill in the art. The resulting spray dried particles, on a dry basis, may comprise 2-100% reclaimed carbon, for example 5-98 wt % or 8-90 wt %, 10-60 wt %, 15-50 wt %, 10-100 wt %, 15-60 wt %, 10-90 wt %, 15-80 wt %, 20-60 wt %, or 30-50 wt %, or 20-50 wt % reclaimed carbon, preferably wet milled reclaimed carbon, and 0-98%, e.g., 2 wt %-95 wt %, e.g., 10 wt % to 92 wt %, 40 to 90 wt %, or 50 wt % to 80 or 85 wt %, additional filler selected from carbon black, silica coated carbon black, silica treated carbon black, precipitated silica, carbon black-coated particles and mixtures of two or more of these, and 0-98%, e.g., e.g., 2 wt %-95 wt %, e.g., 10 wt % to 92 wt %, 40 to 90 wt %, or 50 wt % to 80 or 85 wt %, one or more supplemental fillers selected from to carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.

The wet pellets, dried pellets, and/or spray dried particles according to the various embodiments herein may be combined with elastomer to form elastomer composites. The resulting elastomer composite may include 30-90 phr particulate filler, for example, 30-70, 35-60, or 40-55 phr particulate filler. The particulate filler may include 2-100% reclaimed carbon, for example 5-98 wt % or 8-90 wt %, preferably 10-100 wt %, 10-90 wt %, 15-80 wt %, 20-60 wt %, or 30-50 wt % reclaimed carbon, preferably wet milled reclaimed carbon, exhibiting a volume weighted particle size distribution, measured via scanning electron microscopy, with one or both of D50 no greater than 2700 nm and no more than 15% of particles having a particle diameter greater than 5 microns. For example, either the reclaimed carbon or the overall particulate filler, or both, may exhibit D50 from 1000 to 2700 nm or from 1200 nm to 2500. Alternatively or in addition, the reclaimed carbon, the overall particulate filler, or both, may have D75 from 2500 nm to 3300, for example, from 1700 to 3000. Alternatively or in addition, from 3% to 10% of the reclaimed carbon, the particulate filler, or both, may have a particle diameter greater than 5 microns. Alternatively or in addition, no more than 65% of the reclaimed carbon or the overall particulate filler, for example from 25% to 60%, may have a particle diameter greater than 2 microns. In all of these embodiments, the reclaimed carbon is preferably wet milled reclaimed carbon. Both natural rubber of any grade and synthetic elastomer may be used. Blends of elastomers may also be employed. For example, the wet pellets, dried pellets and/or spray dried particles may be combined with an elastomer to form a masterbatch, which is then combined with additional elastomer of the same or different composition. Alternatively or in addition, two or more elastomers may be blended prior to mixing with the pellets. Alternatively or in addition, the elastomer composite may also contain one or more fillers aside from reclaimed carbon, including any of the particulate fillers listed elsewhere herein and any other fillers known to those of skill in the art for use in elastomer composites. Such fillers may be in a mixture or pellet with the milled reclaimed carbon or may be added to the elastomer separately from any of the wet pellets, dried pellets, and/or spray dried particles according to the various embodiments herein.

The elastomer composite, especially when the filler includes 10-100 wt %, for example, 10-90 wt %, 15-80 wt %, 20-60 wt %, or 30-50 wt % reclaimed carbon, preferably wet milled reclaimed carbon, may exhibit a macrodispersion of at most 0.03x+4.4, for example, from 0.03x to 0.03x+4.4, where x is the percentage of wet milled reclaimed carbon in the particulate filler and macrodispersion is an area percentage of undispersed filler particles (% undispersed area) larger than 5 μm determined by optical microscopy in reflection mode after the sample is cut to reveal the interior. Preferably, macrodispersion is measured on vulcanized elastomer composite. With regards to macrodispersion, the term “particle” is intended to represent an area coverage of particle agglomerates and is differentiated from “primary particles” that form, e.g., a single carbon black aggregate. A carbon black aggregate has dimensions on the order of 0.1 μm scale, which is below the resolution of optical microscopy. This particle “diameter” in conjunction with the macrodispersion measurement is defined herein as an “area-equivalent diameter” of the filler and is typically in the micron size range. Accordingly, the dispersion state can be indicated by a form of particle size distributions, whether by area coverage of the particles, or number of particles per unit area having a certain size.

Alternatively or in addition, when the filler includes only carbon black and 10-100 wt % (filler basis) reclaimed carbon, for example, 10-90 wt %, 15-80 wt %, 20-60 wt %, or 30-50 wt % reclaimed carbon, preferably wet milled reclaimed carbon, may exhibit a macrodispersion of at most 1.9 ln(x)+0.2, for example, from 1.9 ln(x)−3.2 to 1.9 ln(x)+0.2.

Exemplary classes of elastomers include but are not limited to rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene, and the like. The elastomer may have a glass transition temperature (Tg), as measured by differential scanning calorimetry (DSC), ranging from about −120° C. to about 50° C. Examples include, but are not limited to, styrene-butadiene rubbers (SBR), natural rubbers and their functionalized derivatives such as epoxidized and chlorinated rubber, polybutadiene rubbers, polyisoprene rubbers, ethylene-propylene copolymers (e.g., EPDM), isobutylene based rubbers (e.g., butyl rubber), polychloroprene rubbers, nitrile rubbers, hydrogenated nitrile rubbers, polyisoprene rubbers, polysulfide rubbers, polyacrylate elastomers, fluoroelastomers, perfluoroelastomers, and the oil extended derivatives of any of them. Blends and/or functionalized derivatives of any of the foregoing may also be used. Natural rubber may also be treated to chemically or enzymatically modify or reduce various non-rubber components.

Particular suitable synthetic rubbers include: copolymers of from about 10 to about 70 percent by weight of styrene and from about 90 to about 30 percent by weight of butadiene such as copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl-2-vinylpyridine, 5-ethyl-2-vinylpyridine, 2-methyl-5-vinylpyridine, allyl-substituted acrylates, vinyl ketone, methyl isopropenyl ketone, methyl vinyl ether, alpha-methylene carboxylic acids and the esters and amides thereof such as acrylic acid and dialkylacrylic acid amide. Also suitable for use herein are copolymers of ethylene and other high alpha olefins such as propylene, 1-butene and 1-pentene.

The elastomer composite may further comprise additives to facilitate mixing, promote vulcanization, or confer particular properties on a vulcanizate of the elastomer composite. Numerous additives are well known to those skilled in the art and include, for example, adhesion promoters, antioxidants, antiozonants, coupling agents, curatives, degradation inhibitors, plasticizers, processing aids (e.g., liquid polymers, oils and the like), oil extenders, wax, resins, flame-retardants, extender oils, lubricants, tackifiers, vulcanization activators such as zinc oxide and fatty acids, vulcanization accelerators, and a mixture of any of them. Exemplary additives include but are not limited to zinc oxide and stearic acid. The general use and selection of such additives is well known to those skilled in the art.

Dried pellets and/or spray dried pellets may be combined with elastomer as described above using any dry mixing method known to those of skill in the art.

Alternatively or in addition, wet pellets may be combined with elastomer according to the teachings of one or more of US20220332016, WO2021247153, WO2022125679, WO2022125683, WO2022125677, and WO2022125675, the entire contents of all of which are incorporated herein by reference. For example, the wet pellets and elastomer in solid form may be charged into a mixer and mixed under conditions where temperatures are controlled to remove at least a portion of the water in the pellets via evaporation. The elastomer is optionally premasticated prior to introduction of the wet pellets. The wet filler may be added all at once or in aliquots.

Any suitable mixer, such as a Banbury or Brabender mixer or other internal or closed mixer, or an open mixer, or an extruder or a continuous compounder or a kneading mixer or a combination thereof, may be employed to combine wet pellets with elastomer. Other mixers include a kneading type internal mixer. Commercially available internal mixers from Farrel-Pomini, Harburg Freudenberger Maschinenbau GmbH (HF), Kobelco, or Pelmar Eng'r Ltd can be used. Besides the option to use inner circuits of steam or water or other fluid in the rotors, in addition or alternatively, the internal mixer can have cooling or heating jackets at one region or part or more than one region or part of the mixing chamber to control the temperature of the components being mixed therein. This can create one or more heating/cooling zones in a wall or portion of a wall of a mixer. The mixer can be a single stage mixer or a multi-stage mixer (e.g., two stages or more). Examples of mixers and designs that can be utilized are described in European Patent No. 2423253B1 and U.S. Pat. No. 7,556,419, the disclosures of which are incorporated herein by reference.

As another option, the mixer can be a continuous mixer. For example, the solid elastomer and wet filler may be mechanically worked by using one or more of a continuous internal mixer, a twin screw extruder, a single screw extruder, or a roll mill, such as those described in U.S. Pat. No. 9,855,686 B2, the disclosure of which is incorporated herein by reference. Suitable kneading and masticating devices are well known and commercially available, including for example, a Unimix Continuous Mixer and MVX (Mixing, Venting, eXtruding) Machine from Farrel Pomini Corporation of Ansonia, Conn., an FCM™ Farrel Continuous Mixer, a long continuous mixer from Pomini, Inc., a Pomini Continuous Mixer, twin rotor corotating intermeshing extruders, twin rotor counterrotating non-intermeshing extruders, continuous compounding extruders, the biaxial milling extruder produced by Kobe Steel, Ltd., and a Kobe Continuous Mixer. Alternative masticating apparatus suitable for use with one or more embodiments disclosed herein will be familiar to those of skill in the art.

The mixing can be performed with a mixer(s) having at least one rotor and the mixer can be one or more of the following: a kneader, a roll mill, a screw extruder, a twin-screw extruder, a multiple-screw extruder, a continuous compounder, and/or a twin-screw extruder. The mixing can be performed with a mixer(s) having at least one rotor and the mixer can have two-wing rotors, four-wing rotors, six-wing rotors, eight-wing rotors, and/or one or more screw rotors.

The mixing process to combine wet pellets with elastomer may be a one stage (single stage) or multi-stage (multi-step) process. In a multi-stage process, one or more mixers or mixer types may be employed. For stages where an internal mixer is used, the fill factor at each such stage may independently be no more than 72%, no more than 70%, or no more than 68%, or no more than 66%, such as from about 30% to 72%, from 40% to 70%, from 45% to 70%, from 30% to 60%, from 50 to 72%, from 50 to 70%, from 50 to 68%, from 60 to 72%, from 60 to 70%, from 60 to 68%, from 65 to 72%, from 65 to 70%, from 65 to 68%, or from 40 to 60% or from 50 to 60% and the like. The temperature of the mixer may be controlled to control the temperature of the mixture, the amount of water evaporated, or both. For example, in a multi-stage process, the temperature of the mixer for each stage may be controlled to control the amount of water evaporated from the mixture in the first mixing stage and in one or more subsequent stages. For instance, the liquid content of the composite discharged can be lower than the liquid content of the material charged into the mixer by an amount of from 10% to 99.9% (wt. % vs wt. %), from 10% to 95%, or from 10% to 50%. Alternatively or in addition, the rate of rate of liquid release from the composite or mixture during mixing, e.g., by evaporation, can be measured as a time average release rate of the liquid per kg of composite or mixture (e.g., total liquid removed/(release time x composite weight), and this rate can be from 0.01 to 0.14 kg/(min kg) or from 0.01 to 0.07 kg/(min kg) or other rates below or above this range.

Alternatively or in addition, the mixing may be controlled in one or more stages to allow a predetermined total specific energy (energy applied to a mixing system that drives one or more rotors per mass of composite on a dry weight basis), e.g. from 1000 KJ/kg composite (or per kg mixture present in the mixer) to 10,000 KJ/kg composite (or per kg mixture present in the mixer), for example from 2,000 KJ/kg to 5,000 kJ or 1,500 KJ/kg to 8,000 KJ/kg, 1,500 KJ/kg to 7,000 KJ/kg, 1,500 KJ/kg to 6,000 KJ/kg, 1,500 KJ/kg to 5,000 KJ/kg, 1,500 KJ/kg to 3,000 KJ/kg, 1,600 KJ/kg to 8,000 KJ/kg, 1,600 KJ/kg to 7,000 KJ/kg, 1,600 KJ/kg to 6,000 KJ/kg, 1,600 KJ/kg to 5,000 KJ/kg, 1,600 KJ/kg to 4,000 KJ/kg, 1,600 KJ/kg to 3,000 KJ/kg, or other values in any of these ranges. Alternatively or in addition, the specific energy applied to the mixture may be divided to ensure a certain amount of specific energy is applied before or after a portion, e.g., 75% of the filler, is added to the mixer. That is, the filler need not be added all at once. Mixing times at each stage may be any suitable time, for example, from 1 min to 40 min, from 1 min to 20 min, from 1 min to 15 min, from 5 min to 30 min, from 5 min to 20 min, from 5 min to 15 min, or from 1 min to 12 min, from 1 min to 10 min, from 3 min to 30 min. or other times. Alternatively or in addition, the dump discharge temperature for each stage may be from 120° C. to 180° C., 120° C. to 190° C., 130° C. to 180° C., such as from 140° C. to 180° C., from 150° C. to 180° C., from 130° C. to 170° C., from 140° C. to 170° C., from 150° C. to 170° C., or other temperatures within or outside of these ranges.

Following any one or more mixing steps or stages, the resulting composite may be subjected to one or more post-processing steps, for example, to shape or form the composite and/or allow for improved handling. Post-processing may provide a composite that can be dried, homogenized, extruded, calendared, milled, granulated, cut, baled, or sheeted. The composite may be compounded and vulcanized immediately or may be held for a period of time prior to compounding. Suitable equipment for various post-processing steps include but are not limited to one or more of an internal mixer, a kneader, a roll mill, an open mill, a screw extruder, a twin-screw extruder, a multiple-screw extruder, a continuous compounder, and/or a twin screw discharge extruder fitted with a roller die (e.g., twin-screw sheeter) or fitted with stationary knives. Depending on which device or devices are used, it may be desirable to process the composite through the device more than one time or through a series of like or different devices having the same or different operating settings (e.g., speed, temperature, energy input, etc.). Alternatively or in addition, the elastomer composite may be combined with added filler, added elastomer, or both, prior to or as part of the vulcanization process. The additional filler may be the same or different as the particulate filler in the elastomer composite and may include any filler known to those of skill in the art, including the fillers listed as additional and supplemental fillers in this case and including additional wet milled reclaimed carbon. The added filler and or elastomer may increase or decrease the filler loading of the vulcanizate with respect to the elastomer composite.

To vulcanize elastomer composite material, it is combined with a curative package including a cross-linking agent, any necessary activators and accelerators, anti-oxidant, and additional optional additives such as any of those listed above. Where sulfur is used as a cross-linking agent, typical activators include zinc oxide and or stearic acid, and typical accelerators include sulfenamides such as N-tert-butyl-2-benzothiazole sulfenamide (TBBS) and N-cyclohexyl-2-benzothiazole sulfonamide (CBS). Anti-oxidants include N-(1,3-dimethylbutyl)-N′-phenyl-p-phenylenediamine (6PPD) and those listed in WO2012/037244. Other curatives used in rubber processing are peroxides, urethane crosslinkers, metallic oxides, acetoxysilane compounds, and so forth. Additional suitable components for sulfur-based and other cross-linking systems and methods of mixing and vulcanizing elastomer composites are well known to those of skill in the art. For example, typical procedures used for rubber compounding are described in Maurice Morton, Rubber Technology, 3rd Edition, Van Norstrand Reinhold Company, New York 1987, and 2nd Edition, Van Nordstrand Reinhold Company, New York 1973.

A variety of rubber articles may incorporate the vulcanizate. For example, the vulcanizate may be incorporated in a tire, e.g., pneumatic tires, non-pneumatic tires, or solid tires. For example, the vulcanizate may be incorporated in tire treads, tire carcasses, undertread, innerliners, sidewalls, sidewall inserts, wire-skim, or cushion gum for retread tires. Alternatively or in addition, the vulcanizate may be incorporated in hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, oil, aerospace, and other applications, propeller shafts, or linings for pipes to convey, e.g., oil sands or tar sands. Alternatively or in addition, the vulcanizate may be incorporated into engine mounts, bushings, weather stripping, windshield wipers, automotive components, seals, gaskets, housings, and wheel or track elements.

The vulcanized elastomer composite, especially when the filler includes 10-100 wt %, for example, 10-90 wt %, 15-80 wt %, 20-60 wt %, or 30-50 wt % reclaimed carbon, preferably wet milled reclaimed carbon, may exhibit a macrodispersion of at most 0.03x+4.4, e.g., from 0.03x to 0.03x+4.4, where x is the percentage of reclaimed carbon in the particulate filler and macrodispersion is an area percentage of undispersed filler particles larger than 5 μm determined by optical microscopy in reflection mode. Alternatively or in addition, when the filler includes only carbon black and 10-100 wt % (filler basis) reclaimed carbon, for example, 10-90 wt %, 15-80 wt %, 20-60 wt %, or 30-50 wt % reclaimed carbon, preferably wet milled reclaimed carbon, the vulcanized elastomer composite may exhibit a macrodispersion of at most 1.9 ln(x)+0.2, for example, from 1.9 ln(x)−3.2 to 1.9 ln(x)+0.2. The resulting vulcanizate may have fatigue properties equivalent or no more than 10% less than vulcanizates produced via the same process and with the same composition except with ASTM N550 carbon black in place of the reclaimed carbon. Alternatively or in addition, the resulting vulcanizate may have fatigue properties equivalent to or greater than 90% of those for vulcanizates produced via the same process and with the same composition except with the reclaimed carbon substituted by an equal amount of the additional filler employed in the vulcanizate produced according to the invention.

The present invention will be further clarified by the following examples which are intended to be only exemplary in nature

### EXAMPLES

### Example 1

Water processed by reverse osmosis (360 g) and 36 g of a carbon sample (char from either CBP Cyprus or Polimix Ambiental Ltda or Polimix 300 processed reclaimed carbon from Polimix Ambiental Ltda) were charged into a half gallon ball mill containing a mixture of half inch (3320 g) and quarter inch (2130 g) steel media. The mill was run continuously at 82 rpm under ambient conditions for six hours. The water and carbon mixture was removed from the mill and isolated from the milling media. Char and processed reclaimed carbon samples were also jet milled using a 4 inch orbital Micron-Master jet mill from the Jet Pulverizer Company. A vibrating feeder was used to feed solid particulate into an eductor supplied with ambient air at 100 psi and fed to a chamber maintained at 40 psi.

Particle size distribution was evaluated on a Malvern Mastersizer 3000 instrument equipped with a HydroMV recirculation accessory. The HydroMV unit was filled with approximately 100 ml deionized water. The water was recirculated through the detector window and a background measurement made to set a baseline. A 0.02 g sample of dry powder (e.g. char or processed reclaimed carbon) was combined with 50 ml 1:3 (v: v) ethanol/water and 0.05% Triton X100 dispersant. For wet samples and dispersions (e.g., wet milled reclaimed carbon), the solids content of the dispersion was determined and sufficient material was added to a 1:3 ethanol/water mixture to make a dispersion of 0.02 g solids in 50 ml liquid with 0.05% Triton X100 dispersant. For both wet and dry samples, the final mixture was probe sonicated for 10 min at amplitude 50% with a Branson 450D sonicator equipped with a 0.5 inch replaceable titanium tip probe. Freshly dispersed sample was added dropwise to the HydroMV unit until the obscuration level reached about 30%. Recirculation was continued an additional 10 s before the measurement was started. Instrument settings were as set forth in Table 1 below.

TABLE 1

| Particle Type | Non-spherical |
|---|---|
| Refractive Index | 1.840 |
| Absorption Index | 0.846 |
| Dispersant | water |
| Dispersant Refractive Index | 1.333 |
| Background Measurement | 15 seconds red light laser, |
| | 15 seconds blue light laser |
| Sample Measurement | 30 seconds red light laser, |
| | 30 seconds blue light laser |
| Number of Measurements | 5 minimum |
| Sample Obscuration | target 30% (min 20%, max 40%) |
| Stirrer Speed | 1750 rpm |
| Ultrasonic Level | 10% |
| Analysis Model | General purpose |
| Measurement Range | Full scale |
| Result Model | Volume weighted |

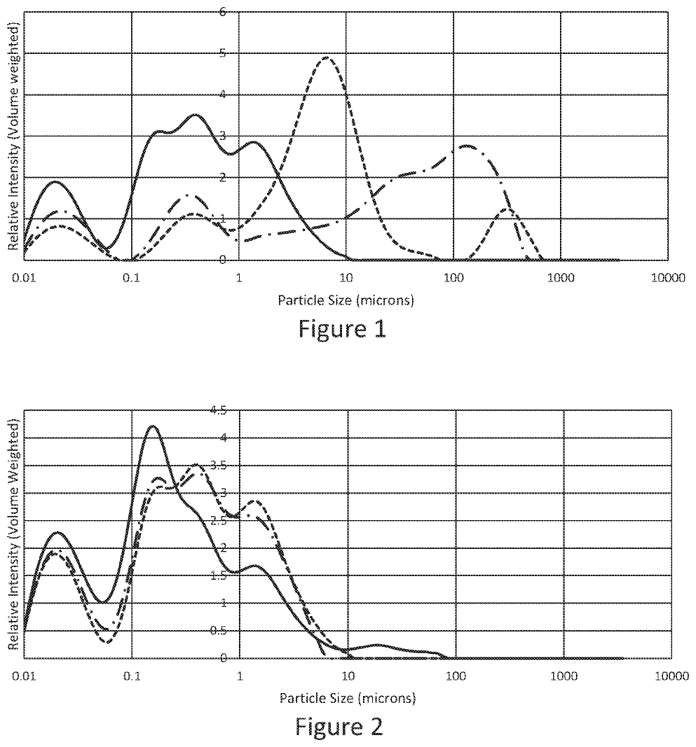

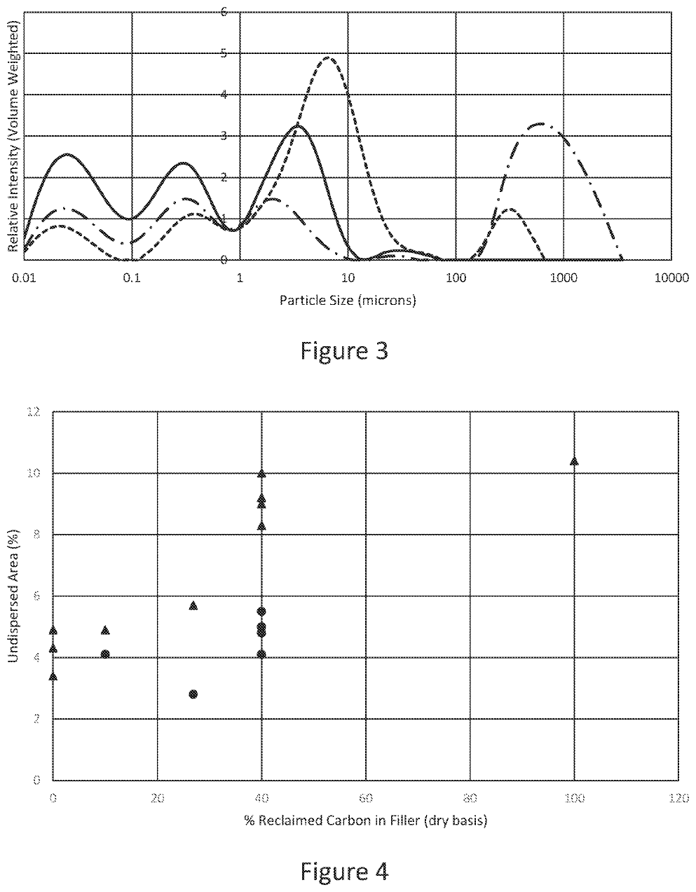

The results are shown in FIGS. 1-3. FIG. 1 shows particle size distributions for unprocessed char (CBP Cyprus) which is unprocessed (dash dot), jet milled (dashed line), or ball milled (solid line). FIG. 2 shows particle size distributions for ball milled samples of char (CBP Cyprus-dashed line- and Polimix Ambiental-dash dot) and processed reclaimed carbon (Polymix 300-solid line). FIG. 3 shows particle size distributions for jet milled samples of char (CBP Cyprus-dashed line- and Polimix Ambiental-dash dot) and Polymix 300 processed reclaimed carbon (solid line). The results show that milling in the presence of water provides more effective milling, with the largest intensity of the distribution curve at a particle size from 0.1 to 2 microns.

### Example 2

1.1 kg of a milled slurry of wet milled reclaimed carbon having a liquid/solid ratio of 10:1 (w/w) mixture is injected into a 20 HP Feeco pin mixer charged with 1 kg fluffy (unpelletized) N550 carbon black at ambient temperature. Mixing continues for 90 s at 1000 rpm, following which pellets are discharged from the mixer. The resulting blended carbon pellets are then dried at 110° C. for 24 h, achieving a moisture content <1%. The dried pellets are then incorporated into a rubber formulation in comparison to reference N550 carbon black.

### Example 3

Ball Milling: Water processed by reverse osmosis and 36 g commercial pyrolysis carbon (Technical Carbon Black, Reoil Sp. z o.o., Myślenice, Poland) were charged into a half gallon ball mill containing a mixture of half inch (3320 g) and quarter inch (2130 g) steel media. Sufficient water was used to produce either an 8.5 (Sample 1) or 20 wt % (Samples 2, 3, 4, 5, and 6) mixture as indicated in Table 2. The mill was operated continuously at 82 rpm under ambient conditions for 24 hours. The resulting mixture was removed from the mill and isolated from the milling media to obtain a slurry of wet milled reclaimed carbon. The process was repeated as needed to obtain sufficient wet milled reclaimed carbon to produce rubber as described below. A 25 wt % slurry was prepared in the same manner and had sufficient flowability to be successfully milled.

Jet-milling: Materials for Comparative 1, 2, 3, 4, and 5 were prepared by jet milling commercial pyrolysis carbon (Technical Carbon Black, Reoil Sp. z o.o., Myślenice, Poland) using a four inch orbital Micron-Master jet mill (Jet Pulverizer Company). A vibrating feeder was used to feed solid particulate into an eductor supplied with ambient air at 80 psi and fed to a chamber maintained at 40 psi at about 60 g/min. ASTM N550 type carbon black (Sterling SO carbon black, Cabot Corporation) was jet milled in the same manner.

Pelletizing: A 10 horsepower pin pelletizer was employed at a fill factor of about 80%. For the Comparative Samples 1, 2, 3, 4 and 5, commercial pyrolysis carbon (Technical Carbon Black, Reoil Sp. z o.o., Myślenice, Poland) that had been jet milled and jet milled ASTM N550 type carbon black was added to the pelletizer in the proportions indicated in Table 2 and mixed for 15 s at 1000 rpm to obtain a homogenous blend of fluffy carbons. The jet milled ASTM N550 type carbon black was added to the pelletizer without blending for Comparative Samples 2a and 5a. Water was then added to the pelletizer at a proportion of about 43 wt % water. For all comparative samples, the pelletizer was operated for one minute at 1000 rpm at ambient temperature. The resulting pellets were used as is or dried to a moisture level below 1 wt % as indicated in Table 2 below. The relative amounts of reclaimed carbon in the resulting pellet are given in Table 2.

For Samples 1-5, an appropriate amount of jet milled carbon black (to give the proportion with wet milled reclaimed carbon set out in Table 2) was added to the pelletizer. Then the slurry obtained from ball milling (Samples 1, 2, 3, 4, and 5). was added to the pin pelletizer to create wetted pellets having 52-62 wt % water. The relative amount of wet milled reclaimed carbon in the resulting pellet and the slurry loading are given in Table 2. For all samples, the pelletizer was operated for one minute at 1000 rpm at ambient temperature. Samples were partially dried (to 43% moisture) or dried to a moisture level below 1 wt % as indicated in Table 2 below. Samples that were partially dried were placed in an oven at 125° C. with a sample depth of approximately 10 mm and checked periodically until the desired moisture level (43 wt % as a percentage of the total weight of wet filler) was reached. Pellet moisture was measured with a Mettler HE53 moisture analyzer (Mettler Toledo). Samples that were dried to a moisture level below 1 wt % were placed in an oven at 125° C. with a sample depth of approximately 10 mm and left overnight.

Comparative Sample 6: Precipitated silica (348 g Zeosil 1165MP silica from Solvay USA, Inc.) and commercial pyrolysis carbon (Technical Carbon Black, Reoil Sp. z o.o., Myślenice, Poland, used as is) were added to a 5 gallon plastic bucket to achieve a mixture with 26.9 wt % pyrolysis carbon. Water was added to the particulate mixture to achieve a moisture level of 52.1 wt %, and the bucket was mixed on a roll mill at 82 rpm for 30 min to form pellets that were not further dried.

Sample 6: Precipitated silica (348 g Zeosil 1165MP silica from Solvay USA, Inc.) and the 20 wt % slurry of wet milled reclaimed carbon were combined in a five gallon plastic bucket to create a mixture with 26.9 wt % (dry basis) wet milled reclaimed carbon and a moisture level of 52.1%. The bucket was agitated on a roll mill at 82 rpm for 30 min to form pellets.

TABLE 2

| | Slurry | | Reclaimed | |
|---|---|---|---|---|
| | Concentration, | | carbon in pellet, | Pellet |
| Experiment | wt. % (solid | Supplemental | wt. % (solid | Moisture, |
| ID | content) | Filler | content) | wt. % |
| Sample 1 | 8.5 | CB | 10.0 | 43 |
| Comparative 1 | N/A | CB | 10 | 43 |
| Comparative 2 | N/A | CB | 40 | 43 |
| Sample 2 | 20 | CB | 40.0 | 43 |
| Comparative 2a | N/A | CB | 0 | 43 |
| Sample 3 | 20 | CB | 40.0 | 43 |
| Comparative 3 | N/A | CB | 40.0 | 43 |
| Sample 4 | 20 | CB | 40.0 | 43 |
| Comparative 4 | N/A | CB | 40.0 | 43 |
| Sample 5 | 20 | CB | 40.0 | <1 |
| Comparative 5 | N/A | CB | 40 | <1 |
| Comparative 5a | N/A | CB | 0 | <1 |
| Sample 6 | 20 | Silica | 26.9 | 52 |
| Comparative 6 | N/A | Silica | 26.9 | 52 |

Particle Size Distribution The particle size distribution (PSD) of the milled reclaimed carbon was measured using a scanning electron microscope. PSD was measured on two separate water-based slurries (listed as separate samples in Table 3 below) for each concentration of wet milled reclaimed carbon (8.5% and 20%), on the water based slurry of wet milled reclaimed carbon and precipitated silica (Sample 6) and on the jet milled reclaimed carbon. The relevant reclaimed carbon sample was gently dispersed at the concentration of 0.2 wt % in water with 600 ppm of Triton X 100 surfactant using a DISPERMAT disperser at 800 RPM for 5 minutes. The 0.2 wt % dispersion was then put on a magnetic stir plate and mixed with a magnetic stir bar for 24 hours. The stirred dispersion was diluted to an appropriate concentration (0.4-4 ppm) for imaging by scanning electron microscopy (SEM) using water with 600 ppm of Triton X 100. The diluted dispersion was vortex mixed at 3000 RPM for 30 seconds; 0.8 mL of the vortexed dispersion was then put onto a 25 mm diameter polycarbonate membrane filter with 100 nm openings for filtering. The particles on the membrane filter were air dried before SEM imaging.

The membrane filters were sputter coated with platinum to reduce charging during imaging. Two sets of SEM images were acquired using a Zeiss Ultra-plus field emission SEM at electron accelerating voltage of 3 kV with a SE2 detector. The first set of 15 to 40 images were acquired at the image pixel size of 60 nm/pixel (1500× magnification) with the field of view of 3072×2304 pixels, and the second set of 15 to 40 images at the image pixel size of 300 nm/pixel (300× magnification) with the field of view of 3072×2304 pixels. The image locations on the membrane filter were randomly selected to cover the whole filter surface area for representative sampling of the particles on the filter surface. Image analysis was performed using macros from the NIH ImageJ software via which SEM images were processed to 1) minimize uneven image background using a pseudo flat-field correction method; 2) increase particle contrast using a local contrast enhancement method with local adaptive histogram equalization in ImageJ, and 3) reduce image noise while preserving the edges of the particles using a bi-exponential edge-preserving smoother in ImageJ. Particles were segmented from the processed SEM images using local contrast differences at three different local region sizes. The size and shape parameters for all particles in the segmented binary images were obtained from the standard particle analysis method in ImageJ. Depending on the breadth of the PSD, a total number of particles of 50000 to 200000 was imaged to achieve appropriate precision. The PSD was generated by combining the PSD of sub micron particles from the set of SEM images at 60 nm/pixel resolution with the PSD of particles larger than or equal to 1 micron from the set of SEM images at 300 nm/pixel resolution. To compensate for the difference in total area for the lower and higher resolution images, each particle compiled from the SEM images with a pixel size of 60 nm was counted with a number weighting factor equal to the ratio of the total number of particles larger than 1 micron in both the set of images with the pixel size of 300 nm and the set of images with the pixel size of 60 nm. To generate a continuous PSD from the list of the discrete particle sizes, a smooth continuous cumulative particle size distribution was generated using a B-spline interpolation algorithm, and the probability-density distribution was then calculated based on the first derivatives of the cumulative distribution using a noise-robust smooth differentiator. The area equivalent circle diameter Dcirc (equal to 2 times the square root of the projected area in the image divided by x) was used as the metric for the particle size. The volume weighting of a particle is based on the volume of the particle estimated from the area and perimeter of the particle in the SEM image using the formula in ASTM D3849. The volume weighted particle size distributions are given in Table 3. The wet milled reclaimed carbon shows a smaller particle size distribution and fewer particles greater than 2 microns and 5 microns than the jet milled reclaimed carbon.

TABLE 3

| | Reclaimed carbon | D50 | D75 | | |
|---|---|---|---|---|---|
| Sample | sample | (nm) | (nm) | >2 μm | >5 μm |
| Slurry 1 | 8.5% ball milled | 2057 | 2849 | 52.1% | 3.8% |
| | slurry | | | | |
| Slurry 2 | 8.5% ball milled | 1693 | 2568 | 39.2% | 13.5% |
| | slurry | | | | |
| Slurry 3 | 20% ball milled | 1453 | 2194 | 30.9% | 3.1% |
| | slurry | | | | |
| Slurry 4 | 20% ball milled | 1253 | 1970 | 33.6% | 7.8% |
| | slurry | | | | |
| Slurry 5 | Ball milled slurry | 1994 | 2718 | 49.8% | 3.4% |
| | with pyrolysis | | | | |
| | carbon and silica | | | | |
| Jetmilled 6 | Jetmilled pyrolysis | 3073 | 4564 | 69.8% | 20.5% |
| | carbon | | | | |

Rubber mixing: Rubber with a particulate loading of 50 phr was prepared using the amounts of smalls and curatives given in Table 4 and SMR20 natural rubber, Buna CB24 butadiene rubber (Lanxess), or Kralex SBR 1502 styrene butadiene rubber (Synthos) as listed in Table 5 below. In addition, two samples were prepared with 100 phr natural rubber (SMR20 grade) via dry mixing using 50 phr as received Sterling SO carbon black (Comparative 7) or commercial pyrolysis carbon (Comparative 8, Technical Carbon Black, Reoil Sp. z o.o., Myślenice, Poland). All compositions were mixed in a 439 mL Brabender Prep-mixer with two cam rotors. Dry mixed samples (pellet moisture <1 wt %) were prepared in two stages as described in Table 6. Wet mixed samples (pellet moisture >1 wt %) were prepared in three stages as described in Table 7. Regardless of which method was used, after each compounding stage, the compounds were sheeted on a 2-roll mill operated at 50° C. and about 22 rpm, followed by banding for 60 seconds and six pass-throughs with a nip gap about 5 mm, with a rest time before next stage of mixing (or curing, after the last stage) of at least 3 hours. Curing was performed in a heated press (150° C., 2500 lbs), for a time T90+10% of T90 as determined by a conventional rubber rheometer, where T90 is the time to achieve 90% vulcanization.

TABLE 4

| | |
|---|---|
| Si69^{a} | 4 |
| 6PPD^{b} | 2 or 2.5 |
| TMQ^{c} | 1.5 |
| Zinc Oxide^{d} | 3 |
| Stearic Acid^{d} | 2 |
| Wax beads^{e} | 1.5 |
| TBBS^{f} | 1.4 |
| Sulfur^{d} | 1.2 |

a) Only used in silica-containing formulations; Bis [3-(triethoxysilyl) propyl]polysulfide from HB Chemical
b) 2 phr for pellets with <1 wt % moisture, otherwise 2.5 phr; N-(1,3-Dimethylbutyl)-N′-phenyl-p-phenylenediamine, Stangard 6PPD (Harwick Standard)
c) poly(1,2-dihydro-2,2,4-trimethyl-quinoline), Antioxidant DQ pellets (Akrochem Corporation)
d) From Akrochem Corporation
e) AKROWAX™ 5031 (Akrochem Corporation)
f) N-tert-butyl-2 benzothiazole sulfenamide (Akrochem Corporation)

TABLE 5

| Experiment ID | NR, phr | SBR, phr | BR, phr |
|---|---|---|---|
| Sample 1 | 100 | 0 | 0 |
| Comparative 1 | 100 | 0 | 0 |
| Sample 2 | 100 | 0 | 0 |
| Comparative 2 | 100 | 0 | 0 |
| Comparative 2a | 100 | 0 | 0 |
| Sample 3 | 0 | 100 | 0 |
| Comparative 3 | 0 | 100 | 0 |
| Sample 4 | 50 | 0 | 50 |
| Comparative 4 | 50 | 0 | 50 |
| Sample 5 | 100 | 0 | 0 |
| Comparative 5 | 100 | 0 | 0 |
| Comparative 5a | 100 | 0 | 0 |
| Sample 6 | 100 | 0 | 0 |
| Comparative 6 | 100 | 0 | 0 |

TABLE 6
Dry mix Protocols - Stage 1

| | |
|---|---|
| Fill Factor, % | 65 |
| Rotor Speed, rpm | 80 |
| Start Temperature, ° C. | 70 |

| Time (s) | Description |
|---|---|
| 0 | Add Polymer |
| 30 | Add ¾ Filler |
| 90 | Scrape/Sweep, add Remaining fillers |
| | and smalls pre-blended (ZnO, Stearic |
| | Acid, Wax, 6PPD, TMQ) |
| | Scrape/Sweep at 140° C. |
| | Dump at 150° C. |

Stage 2

| | |
|---|---|
| Fill Factor, % | 63 |
| Rotor Speed, rpm | 60 |
| Start Temperature, ° C. | 60 |

| Time (s) | Description |
|---|---|
| 0 | Add ½ masterbatch, |
| | curatives and ½ masterbatch. |
| 30 | Scrape/Sweep |
| 90 | Dump - Adjust rotor speed to not exceed |
| | 110° C. |

TABLE 7
Wet mix Protocols - Stage 1

| | |
|---|---|
| Fill Factor, % | 65 |
| Rotor Speed, rpm | 80 |
| Start Temperature, ° C. | 100 |

| Time (s) | Description |
|---|---|
| 0 | Add Polymer |
| 30 | Add ¾ Filler and Si69 if present |
| 90 | Scrape/Sweep, add remaining fillers at 125° C. |
| | Scrape/Sweep and add 2 phr 6PPD at 140° C. |
| | Dump at 150° C. |

Stage 2

| | |
|---|---|
| Fill Factor, % | 63 |
| Rotor Speed, rpm | 70 |
| Start Temperature, ° C. | 60 |

| Time (s) | Description |
|---|---|
| 0 | Add Stage 1 compound |
| 45 | Add smalls pre-blended (ZnO, Stearic |
| | Acid, Wax, 0.5 phr 6PPD, TMQ) |
| 90 | Scrape/Sweep |
| 240 | Dump at 240 seconds or 150° C., |
| | whichever comes first |

Stage 3

| | |
|---|---|
| Fill Factor, % | 61 |
| Rotor Speed, rpm | 60 |
| Start Temperature, ° C. | 60 |

| Time (s) | Description |
|---|---|
| 0 | Add ½ masterbatch, curatives |
| | and ½ masterbatch. |
| 30 | Scrape/Sweep |
| 90 | Dump - Adjust rotor speed to not exceed |
| | 110° C. |

The following tests were used to obtain performance data on each of the vulcanizates. Tensile stress at 100% elongation (M100) and tensile stress at 300% elongation (M300) were evaluated by ASTM D412 (Test Method A, Type C) at 23° C., 50% relative humidity and at crosshead speed of 500 mm/min. Extensometers were used to measure tensile strain. The ratio of M300/M100 is referred to as tensile stress ratio (or modulus ratio). Type B tear strength of cured rubber samples are measured according to ATSM D624 at 23° C. Cured samples were cut on a guillotine to prepare them for macrodisperion analysis. Images were captured digitally using an Idea 5Mp Color Mosaic camera and Spot imaging software version 5.6.11 (Spot Imaging, Sterling Heights, MI) in conjunction with an Olympus BH-2 microscope (a ring light was used as the lighting source in reflection mode). The overall magnification of the captured image was 100×. Picassa (Google) was used to enhance the contrast of the particles against the background. NIH ImageJ software was used to identify and quantify the agglomerates with the default auto thresholding method and appropriate background leveling (set via the background subtraction ball radius) and erosion loops and to distinguish knife marks, which tend to have circularity less than 0.3, from agglomerates (circularity of 0.3 or greater). The ImageJ software was used to define the area equivalent diameter of the corresponding object in the binary image (Area Equivalent Diameter=(4*Area of Dark objects/π)^{1/2}). Three images from randomly selected areas of the sample were measured for each sample, with agglomerates having a diameter of at least 5 microns considered “undispersed”.

The properties of the vulcanizates are listed below in Table 8. The results show that the decreased proportion of large agglomerates in the wet milled reclaimed carbon of the examples correlates with reduced undispersed area and improved modulus ratio and tear strength with respect to elastomer composite vulcanizates having a larger proportion of such agglomerates. The results are shown in FIG. 4. Triangles indicate comparative samples and circles indicate samples prepared according to embodiments of the invention.

TABLE 8

| | 300% Modulus/ | Undispersed Area: |
|---|---|---|
| Experiment ID | 100% Modulus | Digital Photos (%) |
| Sample 1 | 5.5 | 4.1 |
| Comparative 1 | 5.5 | 4.9 |
| Sample 2 | 5.6 | 4.8 |
| Comparative 2 | 5.2 | 8.3 |
| Comparative 2a | 5.2 | 3.4 |
| Sample 3 | 4.7 | 4.1 |
| Comparative 3 | 4.4 | 9.2 |
| Sample 4 | 4.8 | 5.0 |
| Comparative 4 | 4.7 | 10.0 |
| Sample 5 | 5.2 | 5.5 |
| Comparative 5 | 5.2 | 9.0 |
| Comparative 5a | 5.0 | 4.9 |
| Sample 6 | 5.0 | 2.8 |
| Comparative 6 | 5.2 | 5.7 |
| Comparative7 | 5.0 | 4.3 |
| Comparative 8 | 5.3 | 10.4 |

### Example 4

Water processed by reverse osmosis and 36 g commercial pyrolysis carbon (Technical Carbon Black, Reoil Sp. z o.o., Myślenice, Poland) is charged into a half gallon ball mill containing a mixture of half inch (3320 g) and quarter inch (2130 g) steel media. Sufficient water is added to produce a 25 wt % mixture. The mill is operated continuously at 82 rpm under ambient conditions for 24 hours. The resulting mixture was removed from the mill and isolated from the milling media to obtain a slurry of wet milled reclaimed carbon having d50 no greater than 2700 nm and no more than 15% particles having a diameter greater than 5 microns as measured using the SEM method outlined above. The slurry is distilled to remove water until the solids content is about 65-70%, following which the partially dried slurry is dried in an oven at 125° C. until the moisture content is about 40-50%. The resulting wet filler is pelletized as described above. The resulting pellets are used as is without drying or dried to a moisture content of less than 1% and combined with elastomer to form an elastomer composite.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of processing particulate carbon, comprising:
combining pyrolysis carbon with water to form a mixture to form an initial slurry having 1-35 wt % solids; and
milling the pyrolysis carbon to form a milled slurry comprising wet milled reclaimed carbon and water; wherein a volume weighted particle size distribution of the wet milled reclaimed carbon measured via scanning electron microscopy has one or more of D50 no greater than 2700 nm and no more than 15% of particles having a particle diameter greater than 5 microns.

2.-5. (canceled)

6. The method of claim 1, further comprising removing macroscopic contaminants from the initial slurry.

7. (canceled)

8. The method of claim 1, wherein combining further comprises combining at least one supplemental filler with the water to form the initial slurry, wherein the supplemental filler is selected from the group consisting of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, carbon black-coated particles, and mixtures of two or more of these.

9. (canceled)

10. (canceled)

11. The method of claim 1, further comprising adding at least one additional filler selected from carbon black, silicon treated carbon black, silica coated carbon black, carbon black-coated particles, and precipitated silica to the milled slurry to bring the solids content of the resulting wet blended carbon mixture to 25-70 wt %.

12. The method of claim 11, wherein adding comprises adding an aqueous slurry comprising the at least one additional filler.

13. The method of claim 11, further comprising densifying the wet blended carbon mixture by 1) pelletizing the wet blended carbon mixture to form pellets or 2) spray drying the wet blended carbon mixture.

14. (canceled)

15. (canceled)

16. The method of claim 1, wherein:
the water is a continuous stream of water;
the milled slurry is a continuous stream of the milled slurry;
combining comprises metering the pyrolysis carbon into the continuous stream of water.

17.-25. (canceled)

26. Pellets produced by the method of claim 1.

27. Particulate filler comprising at least 10 wt % (dry basis) reclaimed carbon, wherein a volume weighted particle size distribution of the reclaimed carbon measured via scanning electron microscopy has one or more of D50 no greater than 2700 nm and no more than 15% of particles having a particle diameter greater than 5 microns.

28.-32. (canceled)

33. The particulate filler of claim 27, further comprising one or more supplemental fillers selected from carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures and carbon black-coated particles

34.-38. (canceled)

39. A pellet comprising the particulate filler of claim 27 and further comprising at least one additional filler selected from carbon black, silicon treated carbon black, silica coated carbon black, carbon black-coated particles, and precipitated silica.

40. The particulate filler of claim 27, wherein the reclaimed carbon is wet milled reclaimed carbon.

41. An elastomer composite comprising a mixture of an elastomer and 30-90 phr of a particulate filler, wherein the particulate filler comprises at least 10 wt % reclaimed carbon having one or more of D50 (volume weighted) no greater than 2700 nm and no more than 15% (volume weighted) of particles having a particle diameter greater than 5 microns as measured by scanning electron microscopy.

42.-48. (canceled)

49. The elastomer composite of claim 41, wherein the elastomer composite exhibits a macro dispersion from 0.03x to 0.03x+4.4, wherein x is the percentage of reclaimed carbon in the particulate filler and macrodispersion is an area percentage of undispersed filler particles larger than 5 μm determined by optical microscopy in reflection mode.

50. The elastomer composite of claim 41, wherein the particulate filler further comprises one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.

51. The elastomer composite of claim 41, wherein the particulate filler is reclaimed carbon and carbon black and wherein the elastomer composite exhibits a macrodispersion of at most 1.9 ln(x)+1.2, wherein x is the percentage of reclaimed carbon in the particulate filler and macrodispersion is an area percentage of undispersed filler particles larger than 5 μm determined by optical microscopy in reflection mode.

52.-65. (canceled)

66. An elastomer composite comprising a mixture of an elastomer and 30-90 phr of particulate filler, wherein the particulate filler comprises at least 10 wt % reclaimed carbon, wherein the elastomer composite exhibits a macrodispersion of at most 0.03x+4.4, wherein x is the percentage of reclaimed carbon in the particulate filler and macrodispersion is an area percentage of undispersed filler particles larger than 5 μm determined by optical microscopy in reflection mode.

67.-72. (canceled)
